(19) United States
(12) Patent Application Publication
(10) Pub. No.: US 2013/0088542 A1
(43) Pub. Date: Apr. 11, 2013

(54) EPOXY RESIN COMPOSITION

(71) Applicant: CANON KABUSHIKI KAISHA, Tokyo (JP)

(72) Inventor: Akane Hisanaga, Tokyo (JP)

(73) Assignee: CANON KABUSHIKI KAISHA, Tokyo (JP)

(21) Appl. No.: 13/644,083

(22) Filed: Oct. 3, 2012

(30) Foreign Application Priority Data
Oct. 5, 2011 (JP) 2011-221235

(51) Int. Cl. B41J 2/015; C09J 163/02; C08L 63/02

(52) U.S. Cl. 347/20; 523/400; 523/466

(57) ABSTRACT

An epoxy resin contains at least a bisphenol-F-type epoxy resin, a latent hardener, and a thixotropic agent. When the amount of the bisphenol-F-type epoxy resin is 100 parts by mass, the amount of the thixotropic agent is in the range of 3.0 parts by mass to 5.0 parts by mass.

### BACKGROUND OF THE INVENTION

1. Field of the Invention

The present invention relates to an epoxy resin composition.

2. Description of the Related Art

Epoxy resin compositions are widely used to join components of devices in such fields as industrial equipment. For example, Japanese Patent Laid-Open No. 2002-155129 describes a solvent-free epoxy resin composition composed of a liquid epoxy resin and a liquid hardener, and it has excellent adhesive properties. Japanese Patent Laid-Open No. 63-72722 describes a so-called “one-component” thermosetting epoxy resin composition, which can be used without such processes as mixing the base compound and a hardener, and it has excellent hardenability.

When equipment components are joined using a resin composition, two types of problems may be encountered: ones affecting the manufacturing process and ones affecting the product reliability.

Examples of the problems affecting the manufacturing process include the following (1) and (2).

### (1) Pot Life

A known example of the hardeners used to join equipment components is amine-based ones. They offer strong adhesion and thus are good hardeners.

However, many of such amine hardeners are highly reactive and likely to have their viscosity increased and undergo hardening reaction in a few minutes or a few hours even at the ordinary temperature. Using an amine hardener for a long part of a manufacturing process therefore leads to an increased viscosity that can make the control of the amount of the applied resin composition unreliable.

### (2) Shape Retention Properties

In-process industrial equipment, e.g., an in-process inkjet recording head, may have more than one point where adhesive is used to join components. If possible, it is recommended to use a single kind of adhesive at all these points to join the components and thereby complete the equipment; this ensures that the manufacturing process is highly efficient.

However, the points where adhesive is applied have different structures and different shapes and are located in various positions such as the top surface, a lateral surface, and so forth. Thus, some defects may occur depending on where the adhesive is applied: the adhesive may run down the surface just after being applied, or a gap may be formed between the components as the coating loses its thickness after the application process. A temporary decrease in the viscosity of the adhesive during the heating and hardening process may allow the adhesive to flow out of the joint.

On the other hand, examples of the problems affecting the product reliability include the following (3) and (4).

### (3) Adhesion Between Components

The components to be joined may differ from each other in material and/or characteristics such as surface polarity, linear expansion coefficient, and so forth. When two different kinds of components are joined using adhesive, therefore, the adhesive may strongly adhere to one but weakly to the other. A solution to this problem is to improve the adhesion by treating the surface of the components, forming a preliminary coating, and other means, but this leads to an increased number of steps included in the manufacturing process. The adhesion can also be enhanced by thoroughly hardening the adhesive at high temperatures, but heat resistance issues may arise depending on the kinds of materials used.

In particular, inkjet recording heads are produced with their flow passages, liquid chambers, and nozzles where ink flows always immersed in the ink. When components constituting these portions are joined, therefore, the adhesion is affected as the ink or the solvent contained in the ink makes the adhesive swollen or the ink comes into contact with the interfaces between the components and the adhesive, and, eventually, the components may be detached from each other.

### (4) Solvent Resistance of Adhesive

As in the instance of an inkjet recording head, adhesive may be used in a portion with which ink (solvent) comes into contact. If any ingredient of the adhesive is dissolved in the ink, it may affect the ease of ejection of the ink and the pH, viscosity, and other physical properties of the ink. The larger number of ingredients the adhesive contains, the larger number of substances may be dissolved in the ink. Thus, the formula of the adhesive should be as simple as possible.

### SUMMARY OF THE INVENTION

The inventor conducted research on the above problems (1) to (4) and found that the adhesive described in Japanese Patent Laid-Open No. 2002-155129 was disadvantageous with regard to (1), (3), and (4). Likewise, the adhesive described in Japanese Patent Laid-Open No. 63-72722 was found to be disadvantageous with regard to (2).

Aspects of the present invention therefore provide an epoxy resin composition that solves the above problems (1) to (4).

An aspect of the present invention is an epoxy resin composition containing 100 parts by mass of a bisphenol-F-type epoxy resin, a latent hardener, and 3.0 parts by mass to 5.0 parts by mass, both inclusive, of a thixotropic agent.

Further features of the present invention will become apparent from the following description of exemplary embodiments with reference to the attached drawings.

### BRIEF DESCRIPTION OF THE DRAWINGS

FIGS. 1A and 1B are schematic illustrations of an inkjet recording head.

FIG. 2 is a cross-sectional view of the inkjet recording head.

FIG. 3 is another schematic illustration of the inkjet recording head.

### DESCRIPTION OF THE EMBODIMENTS

The following describes aspects of the present invention in detail with reference to embodiments. These embodiments should not be construed as limiting the present invention thereto.

An aspect of the present invention is an epoxy resin composition containing a bisphenol-F-type epoxy resin, a latent hardener, and a thixotropic agent.

### Bisphenol-F-Type Epoxy Resin

The bisphenol-F-type epoxy resin may be any known bisphenol-F-type epoxy resin that has two or more oxirane groups in the molecule.

In aspects of the present invention, using an epoxy resin, in particular, a bisphenol-F-type epoxy resin, as a resin component ensures that in the resulting composition the resin component synergistically works with the latent hardener and the thixotropic agent detailed later herein. As a result, the composition has advantages: (1) it offers a long pot life and excellent storage stability; (2) coatings formed from it can retain their shape well; (3) it can firmly join components of equipment; and (4) hard material made from it is of excellent solvent resistance.

Epoxy resins having a structure different from that of the bisphenol-F-type epoxy resin can also be used in aspects of the present invention. If such epoxy resins are added, their amount may be in the range of 1 part by mass to 50 parts by mass, both inclusive, relative to 100 parts by mass of the bisphenol-F-type epoxy resin.

### Latent Hardener

The term latent hardener represents the hardener that can be stored for a long period of time after mixing in an epoxy resin and initiates hardening reaction when it is exposed to heat, light, pressure, moisture, or any other specific stimulus.

Examples of latent hardeners include tertiary amines and imidazoles, which are dissolved or decomposed and activated by heating and induce self-polymerization of epoxy groups by an anionic mechanism, as well as their salts. Other examples include high-melting point active-hydrogen compounds obtained by addition reaction of dicyandiamide, an organic acid dihydrazide, or a similar chemical with epoxy groups and also include the Lewis acid or Brønsted acid salts that are activated by heating and initiate the polymerization of an epoxy resin by a cationic mechanism. However, high-melting-point active-hydrogen compounds produce their hardening effect only at high temperatures, and Lewis acid or Brønsted acid salts may cause insufficient waterfastness of the resulting composition. On the other hand, tertiary amines, imidazoles, and their salts form less hydroxyl groups through hardening reaction than those formed by acids and primary or secondary amines because the hardener induces epoxy groups to be cross-linked through a self-polymerization reaction. The epoxy resin composition produced in this way is highly resistance to water and polar solvents. Considering these facts, it may be the case that the latent hardener is at least any of a tertiary amine, an imidazole, and their salt. Tertiary amines, imidazoles, and their salts are divided into two types, high-melting-point and dispersive ones and soluble ones, and soluble ones may be provided from the viewpoint of hardening temperature.

Furthermore, when the latent hardener used in aspects of the present invention is a tertiary amine, an imidazole, or the like, it may have a structure in which the tertiary amine or imidazole moiety is masked. The base compound (a bisphenol-F-type epoxy resin) has epoxy groups, and thus a latent hardener having epoxy groups in its chemical structure allows the resin to be adequately dispersed and uniformly hardened. Among latent hardeners having epoxy groups, complex and solid-dispersant hardeners based on epoxy adducts of tertiary amines may be provided. The latent hardener reacts with epoxy groups or promotes self-polymerization of epoxy groups, but not all of it does; some of it is left in the hardened material. In general, tertiary amines have larger molecular weights than those of imidazoles and are nonpolar. This means that tertiary amines are relatively insoluble and advantageous in terms of solvent resistance. A specific example of the tertiary amines that can be used in aspects of the present invention is AH-203 manufactured by Ajinomoto Fine-Techno Co., Inc.

Containing the latent hardener, the resulting epoxy resin composition has a one-component formula. One-component epoxy resin compositions are advantageous over two-component ones because no weighing or mixing process is needed before use, leading to an improved production efficiency, and because the composition can be stored for a long period of time.

In order for the epoxy resin composition according to aspects of the present invention to have satisfactory solvent resistance, it may be the case that the latent hardener content is in the range of 15 parts by mass to 25 parts by mass, both inclusive, relative to 100 parts by mass of the bisphenol-F-type epoxy resin. According to one aspect, the latent hardener content is in the range of 15 parts by mass to 20 parts by mass, both inclusive, relative to 100 parts by mass of the bisphenol-F-type epoxy resin.

### Thixotropic Agent

Thixotropic agents are materials having thixotropy. Thixotropy is the property of a material that temporarily loses its apparent viscosity when it undergoes shear deformation under isothermal conditions but regains its initial apparent viscosity after being allowed to stand for a time. Because of its thixotropy, the composition has good fluidity and is very easy to apply while being applied, and can retain its shape and hardly run down after it is applied. Examples of thixotropic agents include silica fine particles (Aerosil), alumina, mica, and so forth for inorganic ones, and polystyrene oxide-based, polymerized-oil based, surfactant-based, and similar agents for organic ones. Among these, fumed silica, a class of silica fine particles (Aerosil), may be provided in view of its solvent resistance and the effects it has when used in an ink composition. Fumed silica has cross-linking hydrogen bonds formed between surface silanol groups and thus can give thixotropy to the epoxy resin composition even when contained in a small amount.

The particle diameter of the thixotropic agent used in aspects of the present invention may be in the range of 5 nm to 50 nm, both inclusive, such as 5 nm to 20 nm, both inclusive, on the basis of the number-average particle diameter of primary particles.

Specific examples of the thixotropic agent include Aerosil 200, Aerosil RX200, Aerosil RY200, and Aerosil R805 manufactured by Nippon Aerosil Co., Ltd.

In the epoxy resin composition according to aspects of the present invention, the thixotropic agent content is in the range of 3.0 parts by mass to 5.0 parts by mass, both inclusive, relative to 100 parts by mass of the bisphenol-F-type epoxy resin. Adding the thixotropic agent in an amount equal to or larger than 3.0 parts by mass relative to 100 parts by mass of the bisphenol-F-type epoxy resin prevents the hardened material from flowing and spreading. According to one aspect, the thixotropic agent content is equal to or higher than 3.5 parts by mass. Likewise, adding the thixotropic agent in an amount equal to or smaller than 5.0 parts by mass relative to 100 parts by mass of the bisphenol-F-type epoxy resin results in a greater ease of application. According to one aspect, the thixotropic agent content is equal to or lower than 4.0 parts by mass.

### Others

The epoxy resin composition according to aspects of the present invention may further contain a filler. Examples of the filler include silica, diatomaceous earth, alumina, and so forth for inorganic ones, and silicone rubber, methyl methacrylate, polystyrene, and so forth for organic ones. Any single filler or a combination of two or more fillers can be used. In the epoxy resin composition according to aspects of the present invention, however, adjusting the filler content to be lower than the bisphenol-F-type epoxy resin content results in a greater ease of application. More specifically, the filler content is may be equal to or lower than 80 parts by mass relative to 100 parts by mass of the bisphenol-F-type epoxy resin. The epoxy resin composition according to aspects of the present invention can be prepared by, for example, mixing the components described above in a stirring dispersing machine, dispersing them with a bead mill, or dispersing and mixing them using a three-roll mill.

### Inkjet Recording Head

The following describes an inkjet recording head as an example of equipment assembled by joining components with the epoxy resin composition according to aspects of the present invention.

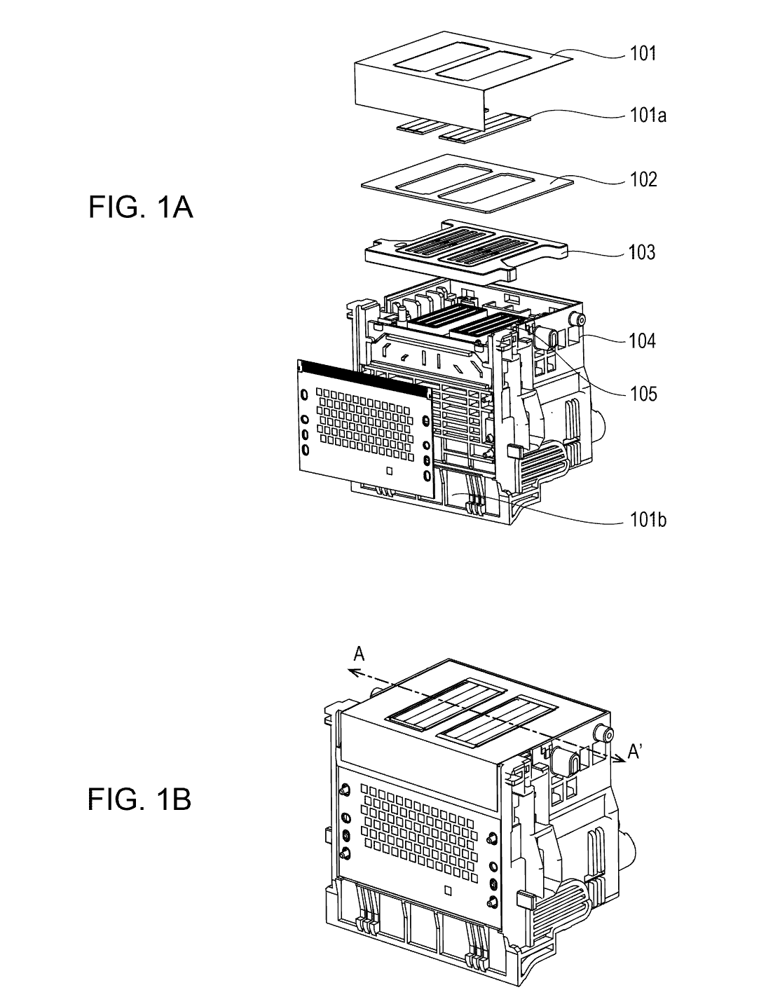

FIG. 1A is an exploded perspective diagram illustrating the constitution of the inkjet recording head, and FIG. 1B is a perspective diagram illustrating the components in the assembled state.

The inkjet recording head illustrated in FIG. 1A has a recording element unit and a chip plate 103. The recording element unit is provided with ink-ejecting nozzles 101a each composed of more than one recording element for ejecting ink, and the chip plate 103 holds this recording element unit fastened thereto. The recording element unit is composed of an electrical wiring sheet 101, recording elements, and a deformation protector 102 for the electrical wiring sheet 101. The electrical wiring sheet 101 is produced by the TAB (tape-automated bonding) process, and each recording element has an ink-ejecting nozzle 101a joined to the electrical wiring sheet 101.

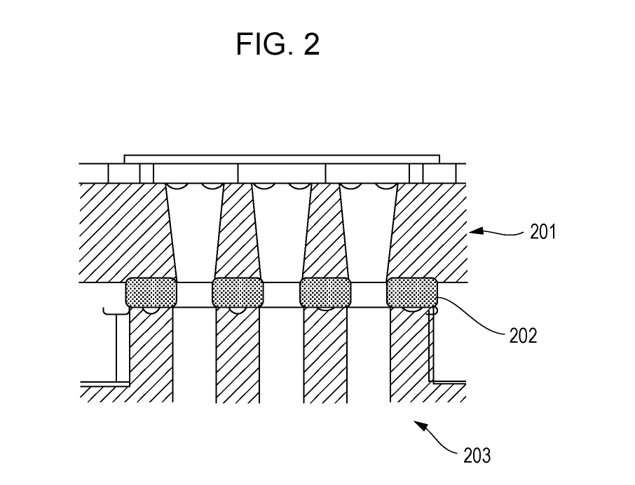

The chip plate 103, which holds the recording element unit fastened thereto, is used in combination with a supporting member 104. In order to ensure good adhesion to the chip plate 103, the supporting member 104 may have a groove to which the adhesive is applied. FIG. 2 shows a cross section in A-A′ in FIG. 1B. As illustrated in FIG. 2, the epoxy resin composition according to aspects of the present invention (adhesive) 202 is interposed between the chip plate 201 and the supporting member 203, joining the two components and also serving as a part of ink flow passages by itself. Supply port 105 is formed to supporting member 104, and wiring board 101b is arranged to supporting member 104.

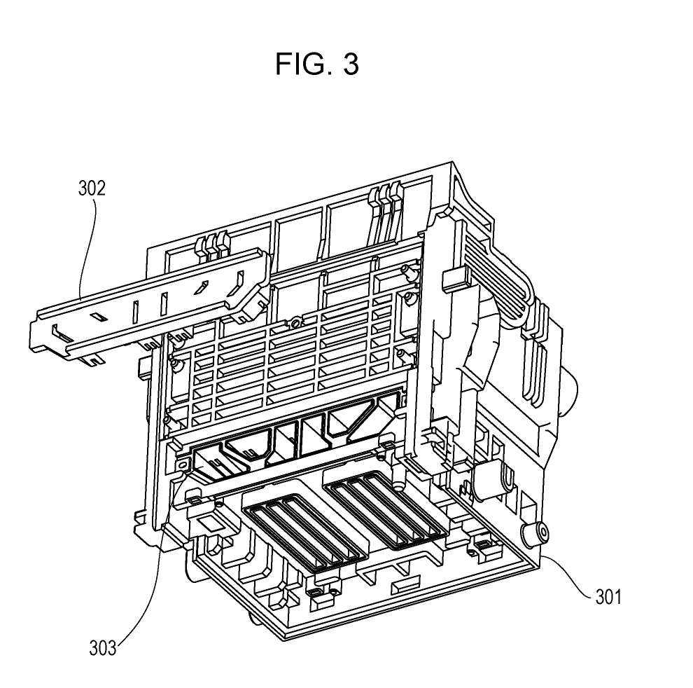

Furthermore, as illustrated in FIG. 3, the supporting member 301 has a liquid chamber 303 and a flow passage forming member 302. The liquid chamber 303 receives ink from an ink tank, stores a certain amount of the ink, and supplies it to the ink-ejecting nozzles 101a, and the flow passage forming member 302 is joined with this liquid chamber 303. The supporting member 301 may have a groove to which the adhesive is applied around the liquid chamber 303 and a projection to be fit into the groove around the flow passage forming member 302. The epoxy resin composition according to aspects of the present invention is interposed between the supporting member and the flow passage forming member and joins these two components.

### Examples

The following describes aspects of the present invention with reference to examples. In the following, the units of measurement “parts” and “%” are all on a mass basis.

### Raw Materials of Epoxy Resin Compositions

The raw materials specified in Tables 1 to 3 below were mixed in V-mini300 Vacuum Mixing-Degassing machine (EME Corporation) in accordance with the formulae specified in Tables 4-1 and 4-2, and thereby the epoxy resin compositions used in Examples and Comparative Examples were obtained. The values presented in Tables 4-1 and 4-2 are all in the unit of parts by mass.

TABLE 1

| | | |
|---|---|---|
| Base | Bisphenol-F-type | EP-49-23 (trade |
| compound | epoxy resin | name), ADEKA |
| | Bisphenol-A-type | EP-4010S (trade |
| | epoxy resin | name), ADEKA |
| | CTBN-modified | TSR-960 (trade |
| | epoxy resin | name), DIC |

TABLE 2

| | | |
|---|---|---|
| Latent | Complex latent | AH-203 (trade name), |
| hardener | hardener | Ajinomoto Fine-Techno |
| | Amine-based | MY-24 (trade name), |
| | latent hardener | Ajinomoto Fine-Techno |
| | Imidazole-based | PN-23 (trade name), |
| | latent hardener | Ajinomoto Fine-Techno |
| | Latent hardener | FXR-1020 (trade name), |
| | based on a modified | Fujikasei Kogyo |
| | aliphatic polyamine | |
| | Latent hardener | EH-4380S (trade name), |
| | based on a special | ADEKA |
| | modified amine | |
| (Non-latent) | Alicyclic acid | HN-5500 (trade name), |
| Hardener | anhydride hardener | Hitachi Chemical |
| | Polyoxyalkylene | T-403 (trade name), |
| | triamine | Mitsui Fine Chemicals |
| | 2-Ethyl-4- | 2E4MZ (trade name), |
| | methylimidazole | Shikoku Chemicals |
| | Thermal cationic | CP-77 (trade name), |
| | polymerization initiator | ADEKA |

TABLE 3

| | | |
|---|---|---|
| Silane | SILQUEST A-187 | Shin-Etsu |
| coupling agent | SILANE (trade name) | Chemical |
| Thixotropic | Aerosil 200 (trade name) | Nippon |
| agent | Aerosil RX200 (trade name) | Aerosil |
| | Aerosil RY200 (trade name) | |
| | Aerosil R805 (trade name) | |
| Inorganic | FB-940 | Denki Kagaku |
| filler | (trade name) | Kogyo |

TABLE 4-1

| | | Examples | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | 13 |
| Base compound | EP-49-23 | 100 | 100 | 100 | 100 | 100 | 100 | 100 | 100 | 100 | 100 | 100 | 100 | 100 |
| | EP-4010S | 0 | 0 | 0 | 0 | 0 | 0 | 0 | 0 | 0 | 0 | 0 | 0 | 0 |
| | TSR-960 | 0 | 0 | 0 | 0 | 0 | 0 | 0 | 0 | 0 | 0 | 0 | 0 | 0 |
| Latent hardener | AH-203 | 10 | 12 | 15 | 18 | 20 | 25 | 15 | 15 | 15 | 15 | 20 | 15 | 15 |
| | MY-24 | 0 | 0 | 0 | 0 | 0 | 0 | 0 | 0 | 0 | 0 | 0 | 0 | 0 |
| | PN-23 | 0 | 0 | 0 | 0 | 0 | 0 | 0 | 0 | 0 | 0 | 0 | 0 | 0 |
| | FXR-1020 | 0 | 0 | 0 | 0 | 0 | 0 | 0 | 0 | 0 | 0 | 0 | 0 | 0 |
| | EH-4380S | 0 | 0 | 0 | 0 | 0 | 0 | 0 | 0 | 0 | 0 | 0 | 0 | 0 |
| Hardener | HN-5500 | 0 | 0 | 0 | 0 | 0 | 0 | 0 | 0 | 0 | 0 | 0 | 0 | 0 |
| | T-403 | 0 | 0 | 0 | 0 | 0 | 0 | 0 | 0 | 0 | 0 | 0 | 0 | 0 |
| | 2E4MZ | 0 | 0 | 0 | 0 | 0 | 0 | 0 | 0 | 0 | 0 | 0 | 0 | 0 |
| | CP-77 | 0 | 0 | 0 | 0 | 0 | 0 | 0 | 0 | 0 | 0 | 0 | 0 | 0 |
| Silane coupling agent | A-187 | 0 | 0 | 0 | 0 | 0 | 0 | 0 | 0.5 | 0 | 0.5 | 0 | 0 | 0 |
| Thixotropic agent | Aerosil 200 | 3.5 | 3.5 | 3.5 | 3.5 | 3.5 | 3.5 | 3.5 | 3.5 | 4.0 | 4.0 | 3.5 | 3.5 | 3.5 |
| | Aerosil RX200 | 0 | 0 | 0 | 0 | 0 | 0 | 0 | 0 | 0 | 0 | 0 | 0 | 0 |
| | Aerosil RY200 | 0 | 0 | 0 | 0 | 0 | 0 | 0 | 0 | 0 | 0 | 0 | 0 | 0 |
| | Aerosil R805 | 0 | 0 | 0 | 0 | 0 | 0 | 0 | 0 | 0 | 0 | 0 | 0 | 0 |
| Inorganic filler | FB-940 | 0 | 0 | 0 | 0 | 0 | 0 | 35 | 35 | 35 | 35 | 35 | 70 | 90 |

| | | Examples | | | | | | | | | | | |
|---|---|---|---|---|---|---|---|---|---|---|---|---|---|
| | | 14 | 15 | 16 | 17 | 18 | 19 | 20 | 21 | 22 | 23 | 24 | 25 |
| Base compound | EP-49-23 | 100 | 100 | 100 | 100 | 100 | 100 | 100 | 100 | 100 | 100 | 100 | 100 |
| | EP-4010S | 0 | 0 | 0 | 0 | 0 | 0 | 0 | 0 | 0 | 0 | 0 | 0 |
| | TSR-960 | 0 | 0 | 0 | 0 | 0 | 0 | 0 | 0 | 0 | 0 | 0 | 0 |
| Latent hardener | AH-203 | 15 | 15 | 25 | 0 | 0 | 0 | 0 | 0 | 15 | 15 | 15 | 28 |
| | MY-24 | 0 | 0 | 0 | 15 | 0 | 0 | 0 | 0 | 0 | 0 | 0 | 0 |
| | PN-23 | 0 | 0 | 0 | 0 | 15 | 0 | 0 | 0 | 0 | 0 | 0 | 0 |
| | FXR-1020 | 0 | 0 | 0 | 0 | 0 | 15 | 15 | 0 | 0 | 0 | 0 | 0 |
| | EH-4380S | 0 | 0 | 0 | 0 | 0 | 0 | 0 | 15 | 0 | 0 | 0 | 0 |
| Hardener | HN-5500 | 0 | 0 | 0 | 0 | 0 | 0 | 0 | 0 | 0 | 0 | 0 | 0 |
| | T-403 | 0 | 0 | 0 | 0 | 0 | 0 | 0 | 0 | 0 | 0 | 0 | 0 |
| | 2E4MZ | 0 | 0 | 0 | 0 | 0 | 0 | 0 | 0 | 0 | 0 | 0 | 0 |
| | CP-77 | 0 | 0 | 0 | 0 | 0 | 0 | 0 | 0 | 0 | 0 | 0 | 0 |
| Silane coupling agent | A-187 | 0 | 0 | 0 | 0 | 0 | 0 | 1.2 | 0 | 0 | 0 | 0 | 0 |
| Thixotropic agent | Aerosil 200 | 3.5 | 3.5 | 3.5 | 3.5 | 3.5 | 3.5 | 3.5 | 3.5 | 0 | 0 | 0 | 3.5 |
| | Aerosil RX200 | 0 | 0 | 0 | 0 | 0 | 0 | 0 | 0 | 3.5 | 0 | 0 | 0 |
| | Aerosil RY200 | 0 | 0 | 0 | 0 | 0 | 0 | 0 | 0 | 0 | 3.5 | 0 | 0 |
| | Aerosil R805 | 0 | 0 | 0 | 0 | 0 | 0 | 0 | 0 | 0 | 0 | 3.5 | 0 |
| Inorganic filler | FB-940 | 0 | 0 | 0 | 0 | 0 | 0 | 0 | 0 | 0 | 0 | 0 | 0 |

TABLE 4-2

| | | Comparative Examples | | | | | | | | | |
|---|---|---|---|---|---|---|---|---|---|---|---|
| | | 1 | 2 | 3 | 4 | 5 | 6 | 7 | 8 | 9 | 10 |
| Base compound | EP-49-23 | 100 | 0 | 0 | 0 | 0 | 0 | 0 | 0 | 0 | 0 |
| | EP-4010S | 0 | 100 | 100 | 100 | 100 | 100 | 100 | 100 | 0 | 0 |
| | TSR-960 | 0 | 0 | 0 | 0 | 0 | 0 | 0 | 0 | 100 | 100 |
| Latent hardener | AH-203 | 15 | 15 | 0 | 0 | 0 | 0 | 0 | 0 | 15 | 15 |
| | MY-24 | 0 | 0 | 15 | 15 | 0 | 0 | 0 | 0 | 0 | 0 |
| | PN-23 | 0 | 0 | 0 | 0 | 15 | 15 | 0 | 0 | 0 | 0 |
| | FXR-1020 | 0 | 0 | 0 | 0 | 0 | 0 | 15 | 0 | 0 | 0 |
| | EH-4380S | 0 | 0 | 0 | 0 | 0 | 0 | 0 | 15 | 0 | 0 |
| Hardener | HN-5500 | 0 | 0 | 0 | 0 | 0 | 0 | 0 | 0 | 0 | 0 |
| | T-403 | 0 | 0 | 0 | 0 | 0 | 0 | 0 | 0 | 0 | 0 |
| | 2E4MZ | 0 | 0 | 0 | 0 | 0 | 0 | 0 | 0 | 0 | 0 |
| | CP-77 | 0 | 0 | 0 | 0 | 0 | 0 | 0 | 0 | 0 | 0 |
| Silane coupling agent | A-187 | 0 | 0 | 0 | 1.2 | 0 | 1.2 | 0 | 0 | 0 | 1.2 |
| Thixotropic agent | Aerosil 200 | 0 | 3.5 | 3.5 | 3.5 | 3.5 | 3.5 | 3.5 | 3.5 | 3.5 | 3.5 |
| | Aerosil RX200 | 0 | 0 | 0 | 0 | 0 | 0 | 0 | 0 | 0 | 0 |
| | Aerosil RY200 | 0 | 0 | 0 | 0 | 0 | 0 | 0 | 0 | 0 | 0 |
| | Aerosil R805 | 0 | 0 | 0 | 0 | 0 | 0 | 0 | 0 | 0 | 0 |
| Inorganic filler | FB-940 | 0 | 0 | 0 | 0 | 0 | 0 | 0 | 0 | 0 | 0 |
| | | Comparative Examples | | | | | | | | | |
| | | 11 | 12 | 13 | 14 | 15 | 16 | 17 | 18 | 19 | 20 |
| Base compound | EP-49-23 | 0 | 0 | 0 | 0 | 100 | 100 | 100 | 100 | 100 | 100 |
| | EP-4010S | 0 | 0 | 0 | 0 | 0 | 0 | 0 | 0 | 0 | 0 |
| | TSR-960 | 100 | 100 | 100 | 100 | 0 | 0 | 0 | 0 | 0 | 0 |
| Latent hardener | AH-203 | 0 | 0 | 0 | 0 | 0 | 0 | 0 | 0 | 15 | 15 |
| | MY-24 | 15 | 0 | 0 | 0 | 0 | 0 | 0 | 0 | 0 | 0 |
| | PN-23 | 0 | 15 | 0 | 0 | 0 | 0 | 0 | 0 | 0 | 0 |
| | FXR-1020 | 0 | 0 | 15 | 0 | 0 | 0 | 0 | 0 | 0 | 0 |
| | EH-4380S | 0 | 0 | 0 | 15 | 0 | 0 | 0 | 0 | 0 | 0 |
| Hardener | HN-5500 | 0 | 0 | 0 | 0 | 80 | 0 | 0 | 0 | 0 | 0 |
| | T-403 | 0 | 0 | 0 | 0 | 0 | 40 | 0 | 0 | 0 | 0 |
| | 2E4MZ | 0 | 0 | 0 | 0 | 1 | 0 | 2 | 0 | 0 | 0 |
| | CP-77 | 0 | 0 | 0 | 0 | 0 | 0 | 0 | 2.5 | 0 | 0 |
| Silane coupling agent | A-187 | 0 | 0 | 0 | 0 | 0 | 0 | 0 | 0 | 0 | 0 |
| Thixotropic agent | Aerosil 200 | 3.5 | 3.5 | 3.5 | 3.5 | 3.5 | 3.5 | 3.5 | 3.5 | 2.5 | 5.5 |
| | Aerosil RX200 | 0 | 0 | 0 | 0 | 0 | 0 | 0 | 0 | 0 | 0 |
| | Aerosil RY200 | 0 | 0 | 0 | 0 | 0 | 0 | 0 | 0 | 0 | 0 |
| | Aerosil R805 | 0 | 0 | 0 | 0 | 0 | 0 | 0 | 0 | 0 | 0 |
| Inorganic filler | FB-940 | 0 | 0 | 0 | 0 | 0 | 0 | 0 | 0 | 0 | 0 |

### Evaluation

The obtained epoxy resin compositions were tested as follows. In each test involving a hardening process, each epoxy resin composition was heated in an oven under the conditions specified in Table 5-1 or 5-2 (indicated by a circle).

### (1) Storage Stability

The epoxy resin composition was stored at an ordinary temperature (25° C.) and monitored for increases in viscosity from the baseline. The viscosity measurements were made using an E-type viscometer at 25° C., and the evaluation was made in accordance with the following criteria: ◯: the percent increase in viscosity was within ±5% after one month of storage; Δ: the viscosity was <2.0 times more than the baseline after one day of storage and ≧1.5 times more than the baseline after one week of storage; x: the viscosity was ≧2.0 times more than the baseline after one day of storage.

### (2) Solvent Resistance

Hard material obtained by hardening 2.5 g of the epoxy resin composition was immersed in 50 mL of a clear ink for 10 hours at 121° C. and 2 atm, and the appearance of the hard material was macroscopically observed. The clear ink used in this test was composed of 9% of glycerin, 9% of triethylene glycol, 5% of methanol, 1% of Acetylenol E100, and water added to make a total of 100%. The evaluation was made in accordance with the following criteria: ◯: no significant swelling or dissolution of the hard material found; x: a significant swelling or dissolution of the hard material was found.

Subsequently, the absorbance of the clear ink was measured on a UV spectrophotometer to determine whether the hard material was dissolved. First, control solution was prepared by leaving the clear ink at 121° C. and 2 atm without adding the hard material to it. Then, the hard material was put into another portion of the clear ink and left under the same conditions, and the absorbance of the ink was measured in a 1-cm quartz cell over a wavelength range of 200 to 400 nm. The evaluation was made on the basis of the measured absorbance in accordance with the following criteria: ◯: <3; Δ: ≧3 to <4; x: ≧4.

Furthermore, the percent swelling of the hard material was calculated from the masses of the hard material before and after it was immersed in the clear ink, and an evaluation was made in accordance with the following criteria: [symbol] : <5%; ◯: ≧5% to <7%; Δ: ≧7% to <10%; x: ≧10%.

### (3) Adhesion Tests

### (3-1) Peeling Tests

The epoxy resin composition was applied to an alumina chip plate and a modified PPE resin plate made of Noryl SE1X (GE Plastics) to form hard coatings each measuring 5.0 cm square. Each hard coating was cut into 2.0 mm squares and subjected to a first peeling test using mending tape (Scotch, Sumitomo 3M Ltd.). Equal amounts of cyan, magenta, and yellow inks were withdrawn from BCI-7 series ink tanks (CANON KABUSHIKI KAISHA) and mixed, and each test specimen was immersed in the ink mixture for 10 hours at 100° C. and 2 atm. The test specimen was then subjected to a second peeling test using the mending tape, and comparisons were made between the initial area of the grid and the areas of the epoxy resin hard coating after the first and second peeling tests. The evaluations were made on the basis of the percent persistence ([area after peeling/initial area of the grid]×100) in accordance with the following criteria: ◯: ≧90% to ≦100%; Δ: ≧50% to <90%; x: <50%.

### (3-2) Destruction Tests

Destruction tests were performed using the components of a recording head designed as illustrated in FIGS. 1 and 3, where each epoxy resin composition was applied to the joints between the chip plate 103 and the supporting member 104 (301) and between the supporting member 301 and the flow passage forming member 302 and then hardened. The materials for the individual components involved were as follows:

Chip plate: alumina;

Supporting member: Noryl RN1300 (GE Plastics);

Flow passage forming member: Noryl SE1X (GE Plastics).

Subsequently, the joints were destroyed and macroscopically observed, and evaluations were made in accordance with the following criteria: ◯: a cohesive failure occurred at the adhesive or any of the components was broken; Δ: the adhesive underwent interfacial delamination and was found hardened on any of the components; x: the adhesive inside the joint was partially in a half-hardened state.

### (4) Ease of Application

Likewise, the ease of application of each epoxy resin composition was evaluated using the components of a recording head designed as illustrated in FIGS. 1 and 3, by applying the epoxy resin composition to the joints between the chip plate 103 and the supporting member 104 (301) and between the supporting member 301 and the flow passage forming member 302 in single motions using a compressed-air dispenser. The coating was macroscopically observed, and an evaluation was made in accordance with the following criteria:

◯: The composition can be smoothly applied in one motion and the formed coating retains its shape well;

Δ: A certain amount of the composition can be applied in one motion and the formed coating retains its shape well;

x: The composition cannot be smoothly applied in one motion or the formed coating cannot retain its shape well.

(5) Flow and Spread after Hardening

Likewise, each epoxy resin composition was assessed for flow and spread after hardening using the components of a recording head designed as illustrated in FIGS. 1 and 3, by applying the epoxy resin composition to the joint between the supporting member 301 and the flow passage forming member 302 and hardening it. The hard material was macroscopically observed, and an evaluation was made in accordance with the following criteria:

◯: The epoxy resin composition remained in the joint and the two components were fastened to each other;

Δ: The two components were fastened to each other but a slight amount of the epoxy resin composition spread out of the joint;

x: The two members were fastened to each other but a considerable amount of the epoxy resin composition spread out of the joint.

The results of the above tests are summarized in Tables 5-1 and 5-2.

TABLE 5-1

| | | | Examples | | | | | | | | | | | | |
|---|---|---|---|---|---|---|---|---|---|---|---|---|---|---|---|
| | | | 1 | 2 | 3 | 4 | 5 | 6 | 7 | 8 | 9 | 10 | 11 | 12 | 13 |
| Hardening | 70° C. × 2.5 hr | | — | — | — | — | — | — | — | — | — | — | — | — | — |
| conditions | 80° C. × 2.0 hr | | — | — | — | — | — | — | — | — | — | — | — | — | — |
| | 100° C. × 2.0 hr | | ◯ | ◯ | ◯ | ◯ | ◯ | ◯ | ◯ | ◯ | ◯ | ◯ | ◯ | ◯ | ◯ |
| | 150° C. × 2.0 hr | | — | — | — | — | — | — | — | — | — | — | — | — | — |
| Storage stability | | | ◯ | ◯ | ◯ | ◯ | ◯ | ◯ | ◯ | ◯ | ◯ | ◯ | ◯ | ◯ | ◯ |
| Solvent | Appearance | | ◯ | ◯ | ◯ | ◯ | ◯ | ◯ | ◯ | ◯ | ◯ | ◯ | ◯ | ◯ | ◯ |
| resistance | Absorbance | | Δ | Δ | ◯ | ◯ | ◯ | ◯ | ◯ | ◯ | ◯ | ◯ | ◯ | ◯ | ◯ |
| | Percent swelling | | [symbol] | [symbol] | [symbol] | [symbol] | [symbol] | [symbol] | [symbol] | [symbol] | [symbol] | [symbol] | [symbol] | [symbol] | [symbol] |
| Peeling | Alumina | Test 1 | ◯ | ◯ | ◯ | ◯ | ◯ | ◯ | ◯ | ◯ | ◯ | ◯ | ◯ | ◯ | ◯ |
| tests | | Test 2 | ◯ | ◯ | ◯ | ◯ | ◯ | ◯ | ◯ | ◯ | ◯ | ◯ | ◯ | ◯ | ◯ |
| | Modified | Test 1 | ◯ | ◯ | ◯ | ◯ | ◯ | ◯ | ◯ | ◯ | ◯ | ◯ | ◯ | ◯ | ◯ |
| | PPE resin | Test 2 | ◯ | ◯ | ◯ | ◯ | ◯ | ◯ | ◯ | ◯ | ◯ | ◯ | ◯ | ◯ | ◯ |

| | | | | | | | | | | | | | | |
|---|---|---|---|---|---|---|---|---|---|---|---|---|---|---|
| Destruction | Chip plate/supporting member | ◯ | [symbol] | [symbol] | [symbol] | [symbol] | [symbol] | [symbol] | [symbol] | [symbol] | [symbol] | [symbol] | [symbol] | [symbol] |
| tests | Supporting member/flow | ◯ | [symbol] | [symbol] | [symbol] | [symbol] | [symbol] | [symbol] | [symbol] | [symbol] | [symbol] | [symbol] | [symbol] | [symbol] |
| | passage forming member | | | | | | | | | | | | | |

| | | | | | | | | | | | | | |
|---|---|---|---|---|---|---|---|---|---|---|---|---|---|
| Ease of application | ◯ | ◯ | ◯ | ◯ | ◯ | ◯ | ◯ | ◯ | ◯ | ◯ | ◯ | ◯ | Δ |
| Flow and spread after hardening | ◯ | ◯ | ◯ | ◯ | ◯ | ◯ | ◯ | ◯ | ◯ | ◯ | ◯ | ◯ | ◯ |

| | | | Examples | | | | | | | | | | | |
|---|---|---|---|---|---|---|---|---|---|---|---|---|---|---|
| | | | 14 | 15 | 16 | 17 | 18 | 19 | 20 | 21 | 22 | 23 | 24 | 25 |
| Hardening | 70° C. × 2.5 hr | | ◯ | — | — | — | — | — | — | — | — | — | — | — |
| conditions | 80° C. × 2.0 hr | | — | ◯ | — | — | — | — | — | — | — | — | — | — |
| | 100° C. × 2.0 hr | | — | — | — | ◯ | ◯ | ◯ | ◯ | ◯ | ◯ | ◯ | ◯ | ◯ |
| | 150° C. × 2.0 hr | | — | — | ◯ | — | — | — | — | — | — | — | — | — |
| Storage stability | | | ◯ | ◯ | ◯ | ◯ | ◯ | ◯ | ◯ | ◯ | ◯ | ◯ | ◯ | ◯ |
| Solvent | Appearance | | ◯ | ◯ | ◯ | ◯ | Δ | ◯ | ◯ | ◯ | ◯ | ◯ | ◯ | ◯ |
| resistance | Absorbance | | Δ | Δ | ◯ | Δ | Δ | ◯ | Δ | ◯ | ◯ | ◯ | ◯ | Δ |
| | Percent swelling | | [symbol] | [symbol] | ◯ | Δ | [symbol] | [symbol] | [symbol] | [symbol] | [symbol] | [symbol] | [symbol] | [symbol] |
| Peeling | Alumina | Test 1 | ◯ | ◯ | ◯ | ◯ | ◯ | ◯ | ◯ | ◯ | ◯ | ◯ | ◯ | ◯ |
| tests | | Test 2 | ◯ | ◯ | ◯ | ◯ | ◯ | Δ | ◯ | ◯ | ◯ | ◯ | ◯ | ◯ |
| | Modified | Test 1 | ◯ | ◯ | ◯ | ◯ | ◯ | ◯ | ◯ | ◯ | ◯ | ◯ | ◯ | ◯ |
| | PPE resin | Test 2 | ◯ | ◯ | ◯ | ◯ | ◯ | ◯ | ◯ | ◯ | ◯ | ◯ | ◯ | ◯ |

| | | | | | | | | | | | | | |
|---|---|---|---|---|---|---|---|---|---|---|---|---|---|
| Destruction | Chip plate/supporting member | [symbol] | [symbol] | [symbol] | ◯ | Δ | Δ | [symbol] | [symbol] | [symbol] | [symbol] | [symbol] | [symbol] |
| tests | Supporting member/flow | [symbol] | [symbol] | [symbol] | ◯ | ◯ | ◯ | [symbol] | [symbol] | [symbol] | [symbol] | [symbol] | [symbol] |
| | passage forming member | | | | | | | | | | | | |

| | | | | | | | | | | | | |
|---|---|---|---|---|---|---|---|---|---|---|---|---|
| Ease of application | ◯ | ◯ | ◯ | ◯ | ◯ | ◯ | ◯ | ◯ | ◯ | ◯ | ◯ | ◯ |
| Flow and spread after hardening | ◯ | ◯ | ◯ | ◯ | ◯ | ◯ | ◯ | ◯ | ◯ | ◯ | ◯ | ◯ |

TABLE 5-2

| | | | Comparative Examples | | | | | | | | | | | | | | | | | | | |
|---|---|---|---|---|---|---|---|---|---|---|---|---|---|---|---|---|---|---|---|---|---|---|
| | | | 1 | 2 | 3 | 4 | 5 | 6 | 7 | 8 | 9 | 10 | 11 | 12 | 13 | 14 | 15 | 16 | 17 | 18 | 19 | 20 |
| Hardening | 70° C. × 2.5 hr | | — | — | — | — | — | — | — | — | — | — | — | — | — | — | — | — | — | — | — | — |
| conditions | 80° C. × 2.0 hr | | — | — | — | — | — | — | — | — | — | — | — | — | — | — | — | — | — | — | — | — |
| | 100° C. × 2.0 hr | | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ |
| | 150° C. × 2.0 hr | | — | — | — | — | — | — | — | — | — | — | — | — | — | — | — | — | — | — | — | — |
| Storage stability | | | ◯ | Δ | ◯ | ◯ | ◯ | ◯ | ◯ | ◯ | ◯ | ◯ | ◯ | ◯ | ◯ | ◯ | ◯ | X | X | ◯ | ◯ | ◯ |
| Solvent | Appearance | | ◯ | ◯ | ◯ | ◯ | ◯ | ◯ | ◯ | ◯ | ◯ | ◯ | ◯ | ◯ | ◯ | ◯ | X | ◯ | ◯ | X | ◯ | ◯ |
| resistance | Absorbance | | ◯ | X | X | X | X | X | X | X | X | X | X | ◯ | X | ◯ | X | ◯ | ◯ | X | ◯ | ◯ |
| | Percent swelling | | [symbol] | X | X | X | Δ | X | X | X | Δ | X | ◯ | [symbol] | Δ | ◯ | ◯ | Δ | X | X | [symbol] | [symbol] |
| Peeling | Alumina | Test 1 | ◯ | ◯ | X | ◯ | ◯ | ◯ | ◯ | ◯ | X | X | X | ◯ | ◯ | ◯ | X | Δ | Δ | X | ◯ | ◯ |
| tests | | Test 2 | ◯ | ◯ | X | ◯ | X | ◯ | ◯ | ◯ | X | X | X | ◯ | ◯ | ◯ | X | X | X | X | ◯ | ◯ |
| | Modified | Test 1 | ◯ | ◯ | X | ◯ | ◯ | ◯ | ◯ | ◯ | ◯ | Δ | ◯ | ◯ | ◯ | ◯ | X | ◯ | ◯ | X | ◯ | ◯ |
| | PPE resin | Test 2 | ◯ | ◯ | X | ◯ | ◯ | ◯ | ◯ | ◯ | ◯ | Δ | ◯ | ◯ | ◯ | ◯ | X | ◯ | ◯ | X | ◯ | ◯ |

| | | | | | | | | | | | | | | | | | | | | | |
|---|---|---|---|---|---|---|---|---|---|---|---|---|---|---|---|---|---|---|---|---|---|
| Destruction | Chip plate/supporting member | [symbol] | ◯ | X | X | X | ◯ | ◯ | ◯ | X | X | X | X | [symbol] | X | X | X | X | X | [symbol] | [symbol] |
| tests | Supporting member/flow | [symbol] | ◯ | X | X | ◯ | ◯ | ◯ | ◯ | X | X | ◯ | Δ | ◯ | Δ | X | ◯ | ◯ | X | [symbol] | [symbol] |
| | passage forming member | | | | | | | | | | | | | | | | | | | | |

| | | | | | | | | | | | | | | | | | | | | |
|---|---|---|---|---|---|---|---|---|---|---|---|---|---|---|---|---|---|---|---|---|
| Ease of application | ◯ | ◯ | ◯ | ◯ | ◯ | ◯ | ◯ | ◯ | ◯ | ◯ | ◯ | ◯ | ◯ | ◯ | X | X | ◯ | ◯ | ◯ | X |
| Flow and spread after hardening | X | ◯ | ◯ | ◯ | ◯ | ◯ | ◯ | ◯ | ◯ | ◯ | ◯ | ◯ | ◯ | ◯ | ◯ | ◯ | ◯ | ◯ | Δ | ◯ |

As can be seen from Table 5-1, the epoxy resin compositions of Examples 1 to 25 were found to be good adhesives.

However, as shown in Table 5-2, the epoxy resin composition of Comparative Example 1, which contained no thixotropic agent, could not retain its shape well, spread in the hardened state, and was of low storage stability. The epoxy resin compositions of Comparative Examples 2 to 14, which contained no bisphenol-F-type epoxy resin, had an unsatisfactory result in solvent resistance and/or adhesion (peeling and destruction tests). The epoxy resin compositions of Comparative Examples 15 to 18, which contained no latent hardener, also had an unsatisfactory result in solvent resistance and/or adhesion. The epoxy resin composition of Comparative Example 19, which contained a thixotropic agent but in a small amount, had an unsatisfactory result in flow and spread after hardening. The epoxy resin composition of Comparative Example 20, which contained an excessive amount of a thixotropic agent relative to the bisphenol-F-type epoxy resin, had an unsatisfactory result in the ease of application.

In conclusion, aspects of the present invention provide an epoxy resin composition that serves as an adhesive characterized in the following: (1) it is of excellent storage stability; (2) coatings formed from it can retain their shape well; (3) it can firmly join components of equipment; and (4) hard material made from it is of excellent solvent resistance.

Aspects of the present invention provide an epoxy resin composition having the following advantages: (1) it offers a long pot life and excellent storage stability; (2) coatings formed from it can retain their shape well; (3) it can firmly join components of equipment; and (4) hard material made from it is of excellent solvent resistance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-221235 filed Oct. 5, 2011, which is hereby incorporated by reference herein in its entirety.

What is claimed is:

1. An epoxy resin composition comprising 100 parts by mass of a bisphenol-F-type epoxy resin, a latent hardener, and 3.0 parts by mass to 5.0 parts by mass, both inclusive, of a thixotropic agent.

2. The epoxy resin composition according to claim 1, wherein the latent hardener is at least any of a tertiary amine and an imidazole.

3. The epoxy resin composition according to claim 1, wherein the thixotropic agent is fumed silica.

4. The epoxy resin composition according to claim 1 for use as an adhesive interposed between a chip plate holding a recording element unit provided with an ink-ejecting nozzle and a supporting member used in combination with the chip plate, the adhesive forming an ink flow passage.

5. The epoxy resin composition according to claim 1, wherein the latent hardener is contained in an amount of 15 parts by mass to 25 parts by mass, both inclusive, relative to 100 parts by mass of the bisphenol-F-type epoxy resin.

6. The epoxy resin composition according to claim 1, wherein the latent hardener is contained in an amount of 15 parts by mass to 20 parts by mass, both inclusive, relative to 100 parts by mass of the bisphenol-F-type epoxy resin.

7. The epoxy resin composition according to claim 1, further comprising a filler.

8. The epoxy resin composition according to claim 7, wherein the filler is contained in an amount of 80 parts by mass or less relative to 100 parts by mass of the bisphenol-F-type epoxy resin.

9. An inkjet recording head comprising a chip plate holding a recording element unit provided with an ink-ejecting nozzle, a supporting member used in combination with the chip plate, and the epoxy resin composition according to claim 1 interposed between the chip plate and the supporting member.
